(19) United States
(12) Patent Application Publication
(10) Pub. No.: US 2023/0358070 A1
(43) Pub. Date: Nov. 9, 2023

(54) Deployable Awning Assembly

(71) Applicant: David Cheplic, Jefferson Hills, PA (US)

(72) Inventor: David Cheplic, Jefferson Hills, PA (US)

(21) Appl. No.: 17/737,376

(22) Filed: May 5, 2022

(51) Int. Cl. E04H 15/08; B60J 9/00

(52) U.S. Cl. CPC E04H 15/08; B60J 9/00

(57) ABSTRACT

A deployable awning assembly includes a tractor trailer that has at least one door which is hingedly coupled to the tractor trailer for accessing an interior of the tractor trailer. An awning frame is movably disposed on the tractor trailer such that the awning frame extends around the at least one door and the awning frame is positionable in a stored position or a deployed position. An awning is rotatably coupled to the awning frame and the awning is positioned in an extended position when the awning frame is positioned in the deployed position having the awning extending away from the tractor trailer to cover a worker when the worker is loading or unloading the tractor trailer. Conversely, the awning is positioned in a retracted position when the awning frame is in the stored position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to awning devices and more particularly pertains to a new awning device for protecting a worker from sun or rain while loading or unloading a tractor trailer. The device includes an awning frame that is pivotally disposed on a tractor trailer such that the awning frame is positionable in a deployed position or a stored position. The device includes an awning that is rotatably disposed on the tractor trailer which extends outwardly from a roof of the tractor trailer when the awning frame is in the deployed position thereby protecting a worker from sun or rain while the worker is loading or unloading the tractor trailer.

### (2) Description of Related Art Including Information Disclosed Under 37 CFR 1.97 and 1.98

The prior art relates to awning devices including an awning mounted to a sidewall of a camper and which includes a plurality of legs, a plurality of springs and plurality of tension lines attached to the springs. The prior art discloses a retractable awning device that includes a housing attached to a sidewall of a structure, an awning frame that includes a pair of first members extending outwardly the housing, a pair of second members each extending between respective first members and the sidewall of the structure and an awning attached to an intersection between the first members and the second members which extends outwardly from the housing. The prior art discloses a retractable awning device that includes a pair of first members each extending away from a sidewall of a recreational vehicle, a spool rotatably mounted to the sidewall, an awning wrapped around the spool and a pair of telescopic members each extending between the first members and the sidewall. The prior art discloses a retractable awning device that includes a case that is mounted to a sidewall of a camper and an awning that is stored within the case. The prior art discloses an awning device that includes a plurality of support members each coupled to a front end of a camper and a rigid shell that is hingedly attached to the front end such that the rigid shell is positionable between a deployed position and a stored position.

### BRIEF SUMMARY OF THE INVENTION

An embodiment of the disclosure meets the needs presented above by generally comprising a tractor trailer that has at least one door which is hingedly coupled to the tractor trailer for accessing an interior of the tractor trailer. An awning frame is movably disposed on the tractor trailer such that the awning frame extends around the at least one door and the awning frame is positionable in a stored position or a deployed position. An awning is rotatably coupled to the awning frame and the awning is positioned in an extended position when the awning frame is positioned in the deployed position having the awning extending away from the tractor trailer to cover a worker when the worker is loading or unloading the tractor trailer. Conversely, the awning is positioned in a retracted position when the awning frame is in the stored position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear perspective view of a deployable awning assembly according to an embodiment of the disclosure showing an awning frame in a stored position.

FIG. 2 is a rear perspective view of an embodiment of the disclosure showing an awning frame and an awning in a deployed position.

FIG. 3 is a right side phantom view of an embodiment of the disclosure showing an awning frame in a stored position.

FIG. 4 is a right side view of an embodiment of the disclosure showing an awning frame and an awning being moved into a deployed position.

FIG. 5 is a cross sectional view taken along line 5-5 of FIG. 1 of an embodiment of the disclosure.

FIG. 6 is a right side perspective view of an alternative embodiment of the disclosure.

FIG. 7 is a back view of an alternative embodiment of the disclosure.

FIG. 8 is a cross sectional view taken along line 8-8 of FIG. 4 of an embodiment of the disclosure.

### DETAILED DESCRIPTION OF THE INVENTION

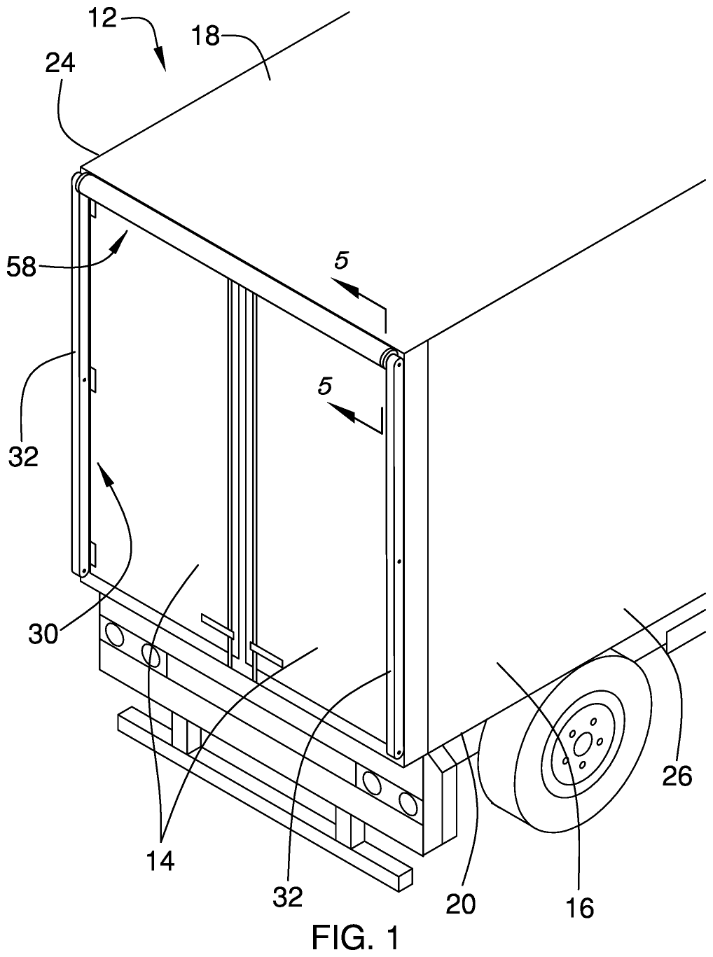

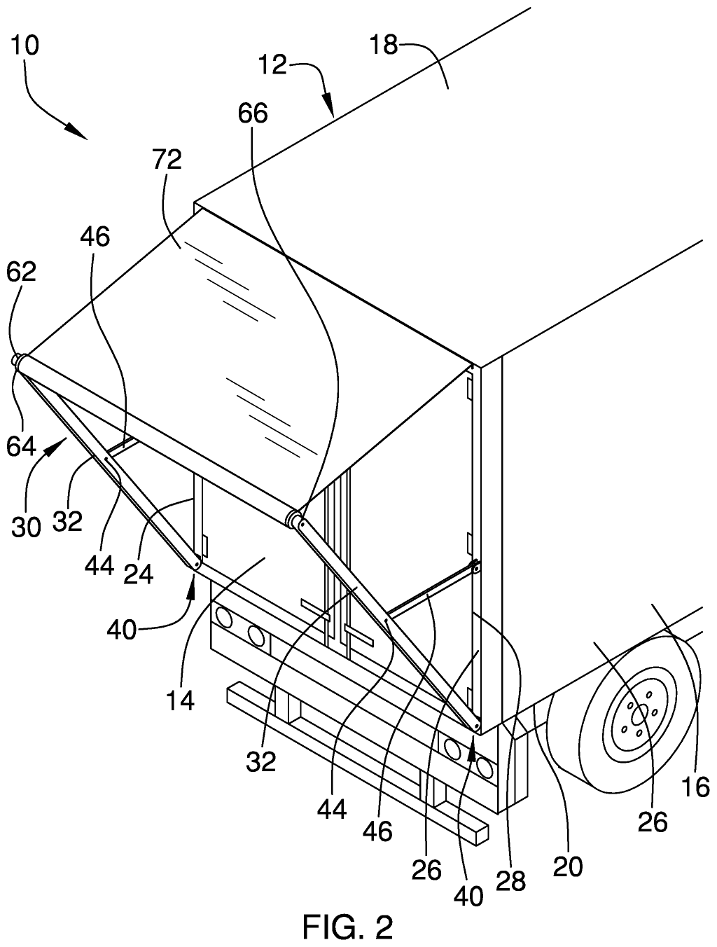

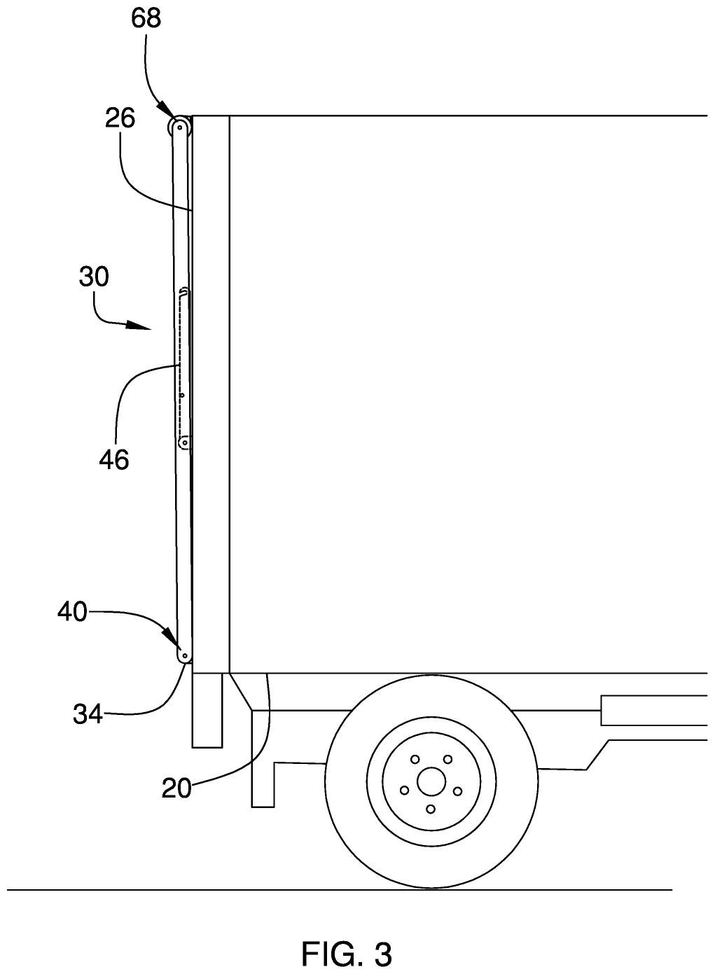

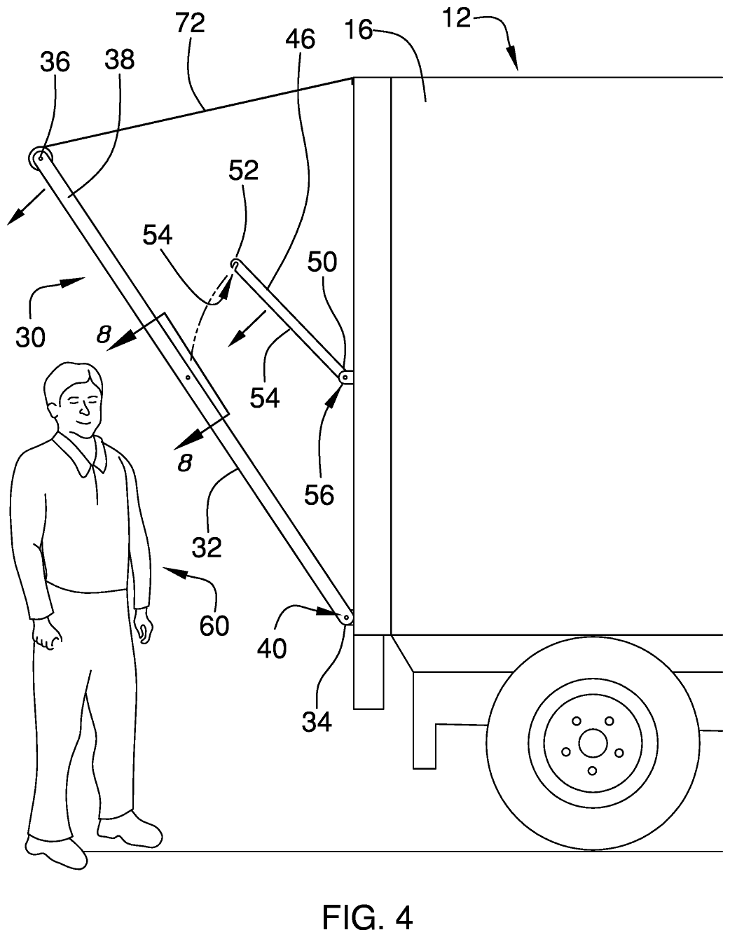

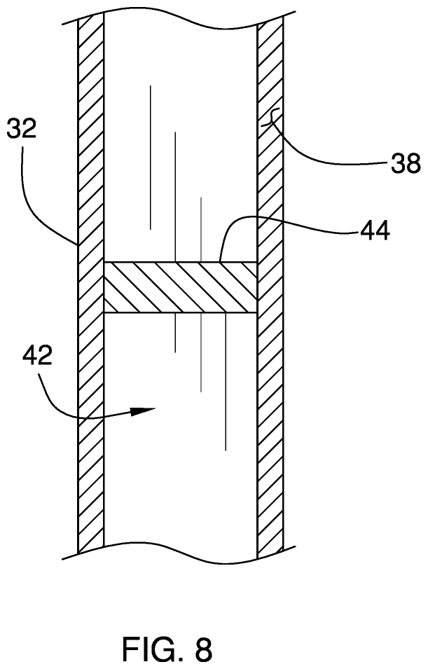

With reference now to the drawings, and in particular to FIGS. 1 through 8 thereof, a new awning device embodying the principles and concepts of an embodiment of the disclosure and generally designated by the reference numeral 10 will be described.

As best illustrated in FIGS. 1 through 8, the deployable awning assembly 10 generally comprises a tractor trailer 12 that has at least one door 14 which is hingedly coupled to the tractor trailer 12 for accessing an interior of the tractor trailer 12. The tractor trailer 12 has an outer wall 16, a roof 18 and a floor 20, and the outer wall 16 has a first lateral side 22, a second lateral side 24 and rear end 26. The rear end 26 has opening 28 extending into the interior of the tractor trailer 12 and the at least one door 14 is hingedly disposed on the rear end 26 for opening or closing the opening 28. The tractor trailer 12 may be a refrigerated trailer, a box trailer or any other type of tractor trailer that is employed for transporting cargo.

An awning frame 30 is movably disposed on the tractor trailer 12 such that the awning frame 30 extends around the at least one door 14 and the awning frame 30 is positionable in a stored position or a deployed position. The awning frame 30 comprises a pair of sidelong members 32 that each has a first end 34, a second end 36 and a rear surface 38 extending between the first end 34 and the second end 36. Each of the sidelong members 32 is elongated between the first end 34 and the second end 36, and the first end 34 of each of the sidelong members 32 is hingedly coupled to the rear end 26 of the tractor trailer 12 at a respective one of a pair of first pivot points 40. Each of the first pivot points 40 is positioned at an intersection between the floor 20 of the tractor trailer 12 and a respective one of the first lateral side 22 and the second lateral side 24 of the outer wall 16 of the tractor trailer 12.

Each of the sidelong members 32 extends upwardly along the respective first lateral side 22 and the second lateral side 24 when the awning frame 30 is in the stored position, and each of the sidelong members 32 angles rearwardly away from the rear end 26 of the tractor trailer 12 when the awning frame 30 is in the deployed position. The rear surface 38 of each of the sidelong members 32 has a groove 42 extending between the first end 34 and the second end 36, and each of the sidelong members 32 has an engagement 44 that is positioned in the groove 42. The engagement 44 on each of the sidelong members 32 is positioned between the first end 34 and the second end 36.

The awning frame 30 includes a pair of support members 46 that each has a primary end 48, a secondary end 50 and a bottom surface 52 extending between the primary end 48 and the secondary end 50. The bottom surface 52 of each of the support members 46 has a slot 54 angling toward the primary end 48 and the slot 54 on each of the support members 46 is positioned adjacent to the primary end 48. The secondary end 50 of each of the support members 46 is hingedly coupled to a respective one of a pair of second pivot points 56 and each of the second pivot points 56 is positioned on the rear end 26 of the tractor trailer 12. Furthermore, each of the second pivot points 56 is aligned with a respective one of the first lateral side 22 and the second lateral side 24 of the outer wall 16 of the tractor trailer 12, and each of the second pivot points 56 is positioned between a respective one of the first pivot points 40 and the roof 18 of the tractor trailer 12.

The slot 54 in the bottom surface 52 of each of the support members 46 receives the engagement 44 on a respective one of the sidelong members 32 when the awning frame 30 is in the deployed position. In this way the sidelong members 32 are retained in an orientation angling away from the rear end 26 of the tractor trailer 12. Conversely, each of the support members 46 lies against the rear end 26 of the tractor trailer 12 when the awning frame 30 is in the stored position. Each of the support members 46 is positioned in the groove 42 in a respective one of the sidelong members 32 when the awning frame 30 is in the stored position.

An awning 58 is provided and the awning 58 is rotatably coupled to the awning frame 30. The awning 58 is positioned in an extended position when the awning frame 30 is positioned in the deployed position having the awning 58 extending away from the tractor trailer 12. In this way the awning 58 can cover a worker 60 when the worker 60 is loading or unloading the tractor trailer 12. Thus, the awning 58 facilitates shade for the worker 60 when the worker 60 is loading or unloading the tractor trailer 12 on a sunny day and the awning 58 facilitates the worker 60 to be dry when the worker 60 is loading or unloading the tractor trailer 12 in the rain. The awning 58 is positioned in a retracted position when the awning frame 30 is in the stored position.

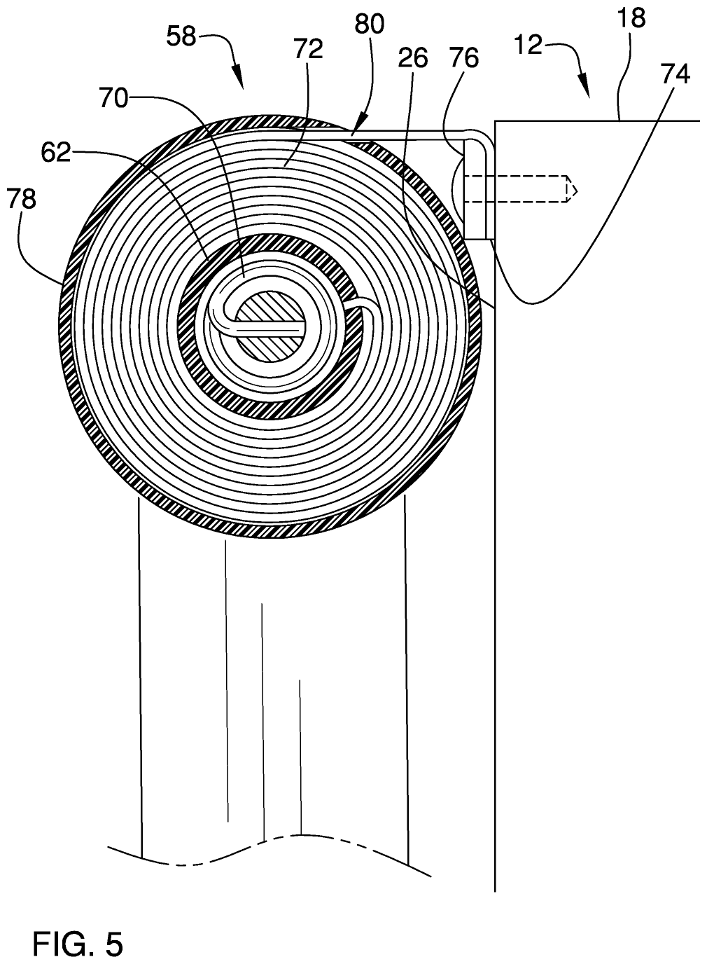

The awning 58 comprises a spool 62 that has a first end 64 and a second end 66, and each of the first end 64 and the second end 66 of the spool 62 is rotatably coupled to a respective one of the sidelong members 32 at a coupling point 68 located adjacent to the second end 36 of the respective sidelong member 32. The spool 62 is biased to rotate in a first direction and the spool 62 is rotatable in a second direction. As is most clearly shown in FIG. 5, a spring biasing member 70 may be integrated into the spool 62 to bias the spool 62 to rotate in the first direction.

The awning 58 includes a canopy 72 that is attached to the spool 62, the canopy 72 has a distal edge 74 with respect to the spool 62 and the distal edge 74 is coupled to the rear end 26 of the tractor trailer 12 at a point that is aligned with the roof 18 of the tractor trailer 12. The canopy 72 is wrapped around the spool 62 when the spool 62 rotates in the first direction and the spool 62 rotates in the first direction when the awning frame 30 is positioned in the stored position. Conversely, the canopy 72 is drawn off of the spool 62 when the spool 62 rotates in the second direction. The spool 62 rotates in the second direction when the awning frame 30 is positioned in the deployed position having the canopy 72 angling downwardly between the roof 18 of the tractor trailer 12 and the spool 62. In this way the canopy 72 facilitates precipitation to run off the canopy 72 when the awning frame 30 is in the deployed position.

As is most clearly shown in FIG. 5, a panel 76 may be fastened to the rear end 26 of the tractor trailer 12, the panel 76 may be aligned with the roof 18 and the awning 58 may be compressed between the rear end 26 of the tractor trailer 12 and the panel 76 to secure the awning 58 to the tractor trailer 12. As is additionally shown in FIG. 5, the spool 62 may include a tube 78 that extends around the spool 62 and the canopy 72, and the tube 78 may have a slot 80 extending along a full length of the tube 78 such that the canopy 72 extends outwardly through the tube 78.

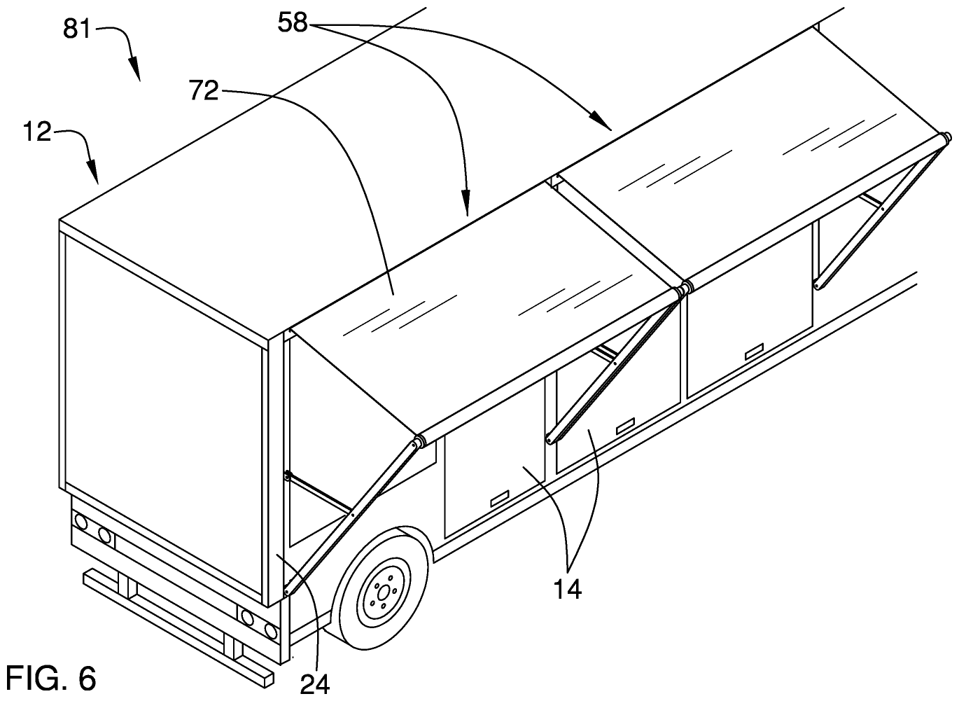

In an alternative embodiment 81 as is most clearly shown in FIG. 6, the tractor trailer 12 may be a side load trailer and the at least one door 14 may be disposed on the second lateral side 24 of the outer wall 16 of the tractor trailer 12. Continuing in the alternative embodiment 81, a plurality of the awning frames 30 is positioned on the second lateral side 24 of the outer wall 16 of the trailer. A plurality of the awnings 58 may each be rotatably disposed on a respective one of the awning frames 30 such that the awnings 58 extend away from the second lateral side 24 of the outer wall 16 of the tractor trailer 12 when the awnings 58 are positioned in the deployed position.

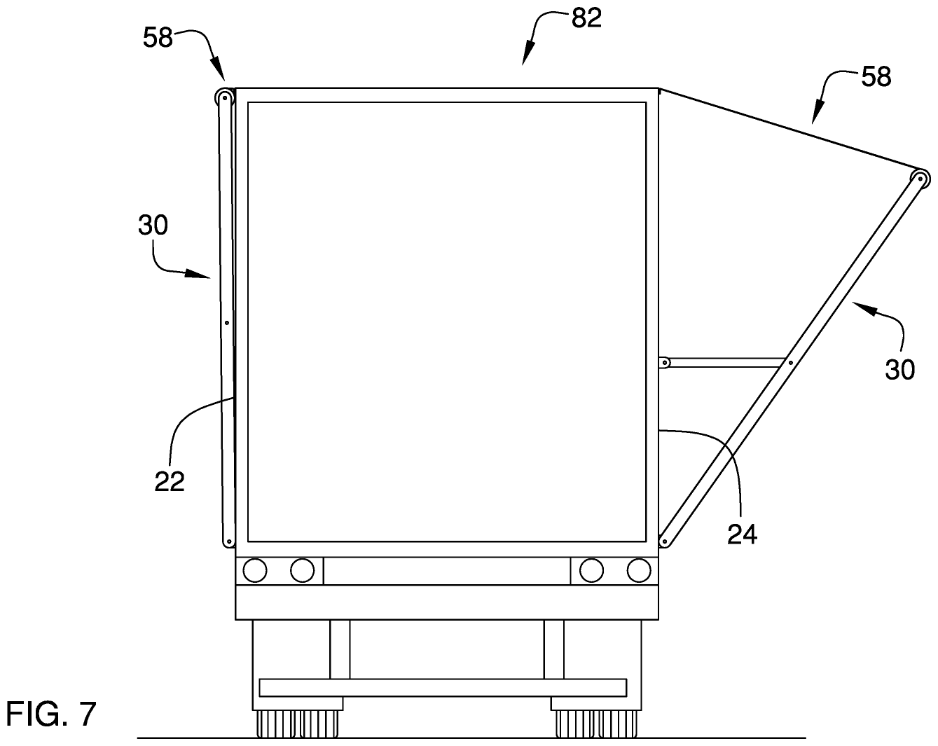

In an alternative embodiment 82 as is most clearly shown in FIG. 7, a respective one of the awning frames 30 may be positioned on a respective one of the first lateral side 22 and the second lateral side 24 of the tractor trailer 12. Additionally, a respective one of the awnings 58 may rotatably disposed on a respective one of the awning frames 30. Each of the awnings 58 may extend away from the respective first lateral side 22 or the second lateral side 24 of the outer wall 16 of the tractor trailer 12 when the awnings 58 are positioned in the deployed position.

In use, the awning frame 30 is urged into the deployed position and each of the support members 46 is positioned such that the slot 54 in each of the support members 46 receives the engagement 44 on the respective sidelong member. In this way the awning frame 30 is retained in the deployed position such that the canopy 72 extends between the tractor trailer 12 and the spool 62. Thus, the canopy 72 facilitates the worker 60 to be shaded or protected from precipitation while the worker 60 is loading or unloading the tractor trailer 12. Each of the support members 46 is disengaged from the engagement 44 on the respective sidelong member 32 thereby facilitating the spool 62 to be biased to rotate in the first direction and subsequently urge the awning frame 30 into the stored position. In this way the awning frame 30 and the awning 58 are stored to facilitate the tractor trailer 12 to be transported as it would normally be.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A deployable awning assembly for protecting a truck driver from the elements while loading or unloading a tractor trailer, said assembly comprising:
a tractor trailer having at least one door being hingedly coupled to said tractor trailer for accessing an interior of said tractor trailer;
an awning frame being movably disposed on said tractor trailer such that said awning frame extends around said at least one door, said awning frame being positionable in a stored position or a deployed position; and
an awning being rotatably coupled to said awning frame, said awning being positioned in an extended position when said awning frame is positioned in said deployed position having said awning extending away from said tractor trailer wherein said awning is configured to cover a worker when the worker is loading or unloading said tractor trailer, said awning being positioned in a retracted position when said awning frame is in said stored position.

2. The assembly according to claim 1, wherein:
said tractor trailer has an outer wall, a roof and a floor, said outer wall having a first lateral side, a second lateral side and rear end, said rear end having opening extending into said interior of said tractor trailer, said at least one door being hingedly disposed on said rear end for opening or closing said opening; and
said awning frame comprises a pair of sidelong members, each of said sidelong members having a first end, a second end and a rear surface extending between said first end and said second end, each of said sidelong members being elongated between said first end and said second end, said first end of each of said sidelong members being hingedly coupled to said rear end of said tractor trailer at a respective one of a pair of first pivot points, each of said first pivot points being positioned at an intersection between said floor of said tractor trailer and a respective one of said first lateral side and said second lateral side of said outer wall of said tractor trailer.

3. The assembly according to claim 2, wherein each of said sidelong members extends upwardly along said respective first lateral side and said second lateral side when said awning frame is in said stored position, each of said sidelong members angling rearwardly away from said rear end of said tractor trailer when said awning frame is in said deployed position.

4. The assembly according to claim 2, wherein:
said rear surface of each of said sidelong members has a groove extending between said first end and said second end; and
each of said sidelong members has an engagement being positioned in said groove, said engagement on each of said sidelong members being positioned between said first end and said second end.

5. The assembly according to claim 4, wherein:
said awing frame includes a pair of support members, each of said support members having a primary end, a secondary end and a bottom surface extending between said primary end and said secondary end, said bottom surface of each of said support members having a slot angling toward said primary end, said slot on each of said support members being positioned adjacent to said primary end;
said second end of each of said support members is hingedly coupled to a respective one of a pair of second pivot points, each of said second pivot points being positioned on said rear end of said tractor trailer, each of said second pivot points being aligned with a respective one of said first lateral side and said second lateral side of said outer wall of said tractor trailer, each of said second pivot points being positioned between a respective one of said first pivot points and said roof of said tractor trailer;
said slot in said bottom surface of each of said support members receives said engagement on a respective one of said sidelong members when said awning frame is in said deployed position for retaining said sidelong members in an orientation angling away from said rear end of said tractor trailer; and
each of said support members lies against said rear end of said tractor trailer when said awning frame is in said stored position, each of said support members being positioned in said groove in a respective one of said sidelong members when said awning frame is in said stored position.

6. The assembly according to claim 2, wherein said awning comprises a spool having a first end and a second end, each of said first end and said second end of said spool being rotatably coupled to a respective one of said sidelong members at a coupling point located adjacent to said second end of said respective sidelong member, said spool being biased to rotate in a first direction, said spool being rotatable in a second direction.

7. The assembly according to claim 6, wherein said awning includes a canopy being attached to said spool, said canopy having a distal edge with respect to said spool, said distal edge being coupled to said rear end of said tractor trailer at a point being aligned with said roof of said tractor trailer, said canopy being wrapped around said spool when said spool rotates in said first direction, said spool rotating in said first direction when said awning frame is positioned in said stored position.

8. The assembly according to claim 7, wherein said canopy is drawn off of said spool when said spool rotates in said second direction, said spool rotating in said second direction when said awning frame is positioned in said deployed position having said canopy angling downwardly between said roof of said tractor trailer and said spool wherein said canopy is configured to facilitate precipitation to run off said canopy when said awning frame is in said deployed position.

9. A deployable awning assembly for protecting a truck driver from the elements while loading or unloading a tractor trailer, said assembly comprising:
a tractor trailer having at least one door being hingedly coupled to said tractor trailer for accessing an interior of said tractor trailer, said tractor trailer having an outer wall, a roof and a floor, said outer wall having a first lateral side, a second lateral side and rear end, said rear end having opening extending into said interior of said tractor trailer, said at least one door being hingedly disposed on said rear end for opening or closing said opening;
an awning frame being movably disposed on said tractor trailer such that said awning frame extends around said at least one door, said awning frame being positionable in a stored position or a deployed position, said awning frame comprising:
a pair of sidelong members, each of said sidelong members having a first end, a second end and a rear surface extending between said first end and said second end, each of said sidelong members being elongated between said first end and said second end, said first end of each of said sidelong members being hingedly coupled to said rear end of said tractor trailer at a respective one of a pair of first pivot points, each of said first pivot points being positioned at an intersection between said floor of said tractor trailer and a respective one of said first lateral side and said second lateral side of said outer wall of said tractor trailer, each of said sidelong members extending upwardly along said respective first lateral side and said second lateral side when said awning frame is in said stored position, each of said sidelong members angling rearwardly away from said rear end of said tractor trailer when said awning frame is in said deployed position, said rear surface of each of said sidelong members having a groove extending between said first end and said second end, each of said sidelong members having an engagement being positioned in said groove, said engagement on each of said sidelong members being positioned between said first end and said second end; and
a pair of support members, each of said support members having a primary end, a secondary end and a bottom surface extending between said primary end and said secondary end, bottom surface of each of said support members having a slot angling toward said primary end, said slot on each of said support members being positioned adjacent to said primary end, said second end of each of said support members being hingedly coupled to a respective one of a pair of second pivot points, each of said second pivot points being positioned on said rear end of said tractor trailer, each of said second pivot points being aligned with a respective one of said first lateral side and said second lateral side of said outer wall of said tractor trailer, each of said second pivot points being positioned between a respective one of said first pivot points and said roof of said tractor trailer, said slot in said bottom surface of each of said support members receiving said engagement on a respective one of said sidelong members when said awning frame is in said deployed position for retaining said sidelong members in an orientation angling away from said rear end of said tractor trailer, each of said support members lying against said rear end of said tractor trailer when said awning frame is in said stored position, each of said support members being positioned in said groove in a respective one of said sidelong members when said awning frame is in said stored position;
an awning being rotatably coupled to said awning frame, said awning being positioned in an extended position when said awning frame is positioned in said deployed position having said awning extending away from said tractor trailer wherein said awning is configured to cover a worker when the worker is loading or unloading said tractor trailer, said awning being positioned in a retracted position when said awning frame is in said stored position, said awning comprising:
a spool having a first end and a second end, each of said first end and said second end of said spool being rotatably coupled to a respective one of said sidelong members at a coupling point located adjacent to said second end of said respective sidelong member, said spool being biased to rotate in a first direction, said spool being rotatable in a second direction; and
a canopy being attached to said spool, said canopy having a distal edge with respect to said spool, said distal edge being coupled to said rear end of said tractor trailer at a point being aligned with said roof of said tractor trailer, said canopy being wrapped around said spool when said spool rotates in said first direction, said spool rotating in said first direction when said awning frame is positioned in said stored position, said canopy being drawn off of said spool when said spool rotates in said second direction, said spool rotating in said second direction when said awning frame is positioned in said deployed position having said canopy angling downwardly between said roof of said tractor trailer and said spool wherein said canopy is configured to facilitate precipitation to run off said canopy when said awning frame is in said deployed position.

10. The assembly according to claim 9, wherein:
said at least one door is disposed on said second lateral side of said outer wall of said tractor trailer;
a plurality of said awning frames is positioned on said second lateral side of said outer wall of said trailer; and
a plurality of said awnings is rotatably disposed on a respective one of said awning frames such that said awnings extends away from said second lateral side of said outer wall of said tractor trailer when said awnings is positioned in said deployed position.

11. The assembly according to claim 12, wherein:
a respective one of said awning frames is positioned on a respective one of said first lateral side and said second lateral side of said tractor trailer; and
a respective one of said awnings is rotatably disposed on a respective one of said awning frames, each of said awnings extends away from said respective first lateral side or said second lateral side of said outer wall of said tractor trailer when said awnings are positioned in said deployed position.
